(19) United States
(12) Patent Application Publication
(10) Pub. No.: US 2014/0129483 A1
(43) Pub. Date: May 8, 2014

(54) System and Method of Determining Access to a Cloud Service

(71) Applicant: ABBYY SOFTWARE LTD., Nicosia (CY)

(72) Inventors: Andrey Isaev, Moscow (RU); Semyon Sergunin, Fremont (US)

(73) Assignee: ABBYY SOFTWARE LTD., Nicosia (CY)

(21) Appl. No.: 13/672,595

(22) Filed: Nov. 8, 2012

(51) Int. Cl. G06F 17/00

(52) U.S. Cl. CPC G06F 17/602
USPC 705/400

(57) ABSTRACT

The present invention provides a method of predicting usage of and determining access to a cloud service according to an embodiment of the invention. The method includes the step of monitoring the usage of a service by end users of developers for a predetermined test period. Responsive to statistics associated with the monitoring during the predetermined test period, the method includes determining a future usage payment cost for the developers. Responsive to verification of a unique ID, the method includes performing the service by a service provider.

### BACKGROUND

1. Field

The present invention is related generally to software licensing, mobile devices, cloud computing, and in one example embodiment, to a method for providing software services in a cloud environment.

2. Related Art

Programs for mobile devices (mobile programs) sold by developers are often sold to end users at a low fixed price and often the mobile programs sold do not have an expiration date. Some mobile programs do not include all of the functionality required to process their data files and may access existing cloud services to perform some of these required functions. For example, a check processing program that allows end users to photograph their checks may use an OCR service to perform the OCR function. To provide access of these services to the end user, the mobile program developer may pay a periodic, continual fee so that the OCR service provider will provide continued access and use of the OCR service to the end users of the check processing program.

One problem is that the payment model used by service provider and the software developer may not be compatible. For example, the payment type for the billing and collection methods for the mobile program may not be the same. The developer may charge a onetime flat payment to the end user while the service provider may collect a continual, periodic payment from the developer. In one example, the developer makes periodic payments based on the usage term (monthly or annual payments), periodic payments based on the amount of usage of the services by the end user, and/or a combination of the two types of payments. However, before the end user's installation of the mobile program, the developer does not know the amount of usage of the service during the entire term of use. Therefore, it is may be difficult for the developer to accurately predict the volume of services necessary for each end user. The incompatibility of payment models makes it difficult for the developer to determine the optimum fee to charge the end user and makes the payment model riskier for maintaining profitability.

Another problem with a services model based on a usage are difficulties keeping track of the number of copies processed by the service by each end user and associating the number of copies used by the end user with the correct developer. Because the usage number by each developer and each end user can be used in determining the periodic payments to the cloud service provider, both the mobile program developer and service provider may need sophisticated systems to keep track of the usage of service. In one example, the service provider may need sophisticated systems to keep track of the number of recognized pages. Communicating and keeping track of usage, the balance of the account, the time period during which the service is utilized, etc. can require sophisticated accounting systems by the service provider and the developer.

### SUMMARY

The present invention provides a method of predicting usage of and determining access to a cloud service according to an embodiment of the invention. The method includes the steps of: monitoring the usage of a service by end users of developers for a predetermined test period; based on the statistics associated with the monitoring during the predetermined test period, determining a future usage payment cost for the developers; based upon verification of receipt of a valid unique ID performing the service wherein the service is performed by a service provider.

This Summary has introduced a non-exclusive selection of aspects or concepts about the present invention in a simplified form that are further described below in the Detailed Description. This Summary is not intended to identify key or essential features of the claimed subject matter, and is not intended to be used to limit the scope of the claimed subject matter.

### BRIEF DESCRIPTION OF THE DRAWINGS

While the appended claims set forth the features of the present invention with particularity, the invention, together with its objects and advantages, will be more readily appreciated from the following detailed description, taken in conjunction with the accompanying drawings. Throughout, like numerals refer to like parts with the first digit of each numeral generally referring to the FIG. which first illustrates the particular part.

FIG. 1A shows a flowchart of the method for determining access to a usage based cloud service based on an embodiment of the invention;

FIG. 1B shows a flowchart of a method for determining a future usage payment cost model according to an embodiment of the invention;

FIG. 2A shows a block diagram of an exemplary system for determining access to a usage based cloud service according to an embodiment of the invention;

FIG. 2B shows a block diagram of an exemplary system for determining access to multiple usage based cloud services according to an embodiment of the invention;

FIG. 3 shows an example of mathematical function that approximates a relationship between service usage per day and time according to the method shown in FIG. 1B;

FIG. 4 shows a system for managing access to a cloud service according to an embodiment of the invention;

FIG. 5 shows a block diagram of a system for managing access to a cloud service on which a computer readable medium may be used to receive program instructions for the method shown in FIG. 1A according to an embodiment of the invention.

### DETAILED DESCRIPTION

In the following description, for purposes of explanation, numerous specific details are set forth in order to provide an understanding of the invention. It will be apparent, however, to one skilled in the art that the invention can be practiced without these specific details. In other instances, structures and devices are shown only in block diagram form in order to avoid obscuring the invention.

Reference in this specification to “one embodiment” or “an embodiment” means that a particular feature, structure, or characteristic described in connection with the embodiment is included in at least one embodiment of the invention. Appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but no other embodiments.

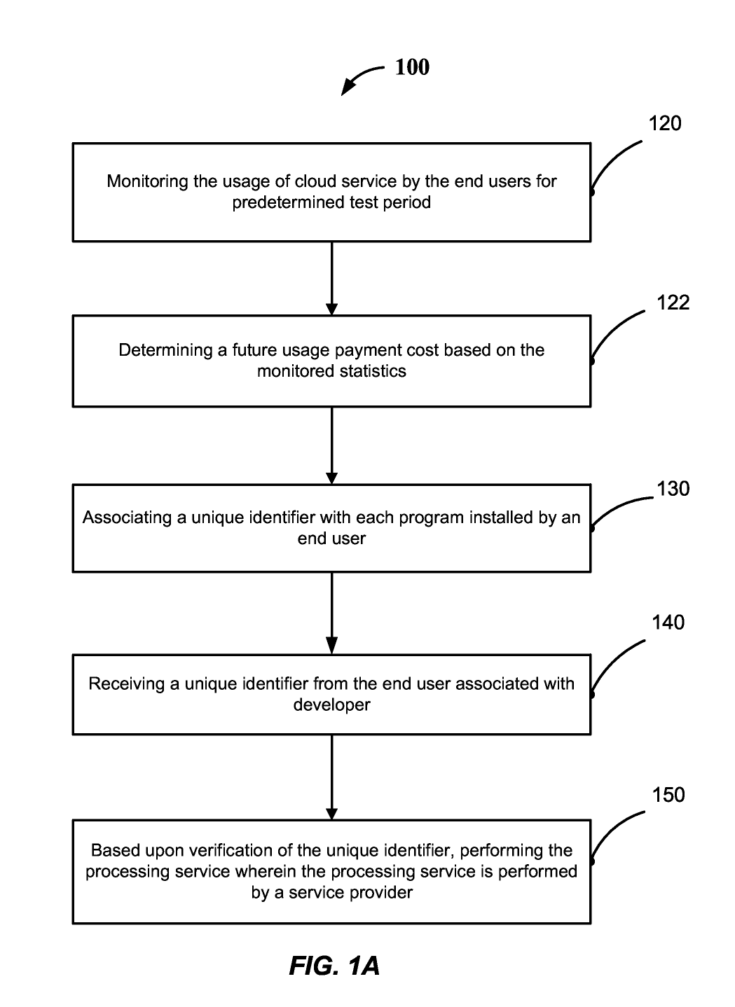

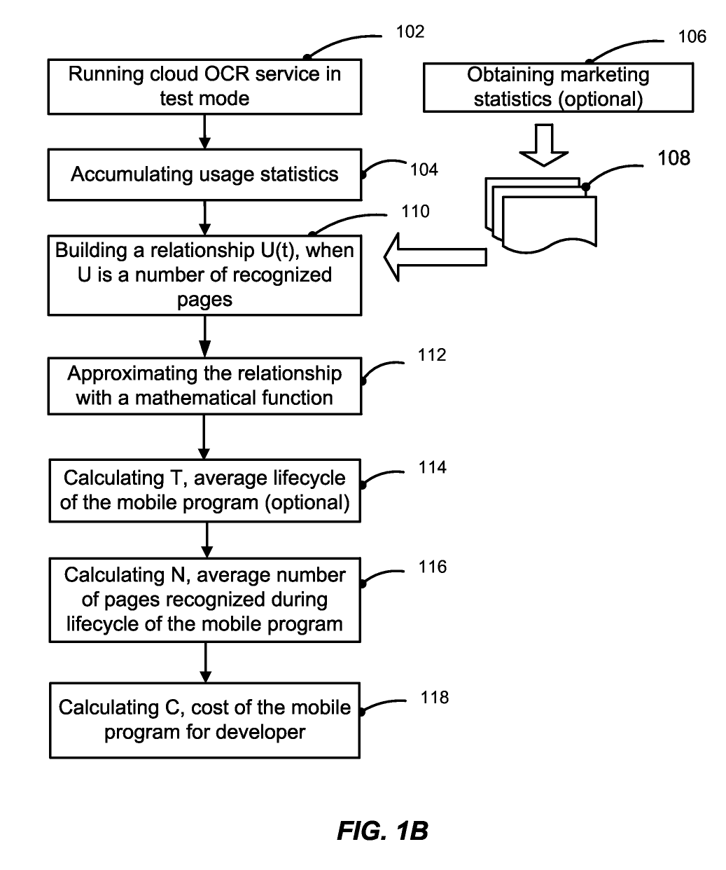

The present invention provides a method of predicting usage of and determining access to a cloud service according to an embodiment of the invention. Referring to FIG. 1A, the method 100 includes the steps of: monitoring the usage of a service by end users of developers for a predetermined test period (step 120); based on the statistics associated with the monitoring during the predetermined test period, determining a future usage payment cost for developers (step 122); based upon verification of a unique ID, performing a service wherein the service is performed by a service provider (step 150).

It is noted here that while the expression “unique ID” is used, the term unique includes the use of unique, semi-unique and other terms related to identifiable, distinguishable or trackable entities. Thus, as long as the entity is trackable or distinguishable from other entities, the unique ID can be considered unique and is not limited to purely unique ID's.

The described method helps to minimize the problems associated with incompatible billing methods by providing a future usage payment cost associated with the usage by the end users of a mobile program. Because the billing and collection models are both based on a fixed fee payment model (the mobile program developer charges a single flat fee to the end user and the cloud services provider collects a single flat fee payment from the mobile program developer) determining the optimal fee is simplified. Because the developer knows the future cost for the service (a onetime fixed fee future usage payment cost), it is easier for the developer to charge the end user of the mobile program the optimal cost—a mobile program cost which provides mobile program developer his desired profit while still paying for the end user's anticipated usage. Further, the provider of the cloud service is adequately compensated for the projected usage of the service.

In one embodiment, there is no limitation on the usage of the cloud service by the end user. For example for an OCR cloud service, there is no limit to the number of recognized pages provided to each end user of the mobile device who purchases a mobile program from the program developer. The statistics computed by monitoring the program for the OCR service provider provides an estimate for the number of pages to be recognized. In addition, in one example, the program used in the proposed method does not have an expiration date. Again, the statistics computed by monitoring the usage by the mobile programs for the service provider provides an estimate for the lifecycle of the program so that the lifetime usage of the service can be estimated and a fair amount can be charged to the mobile program developer.

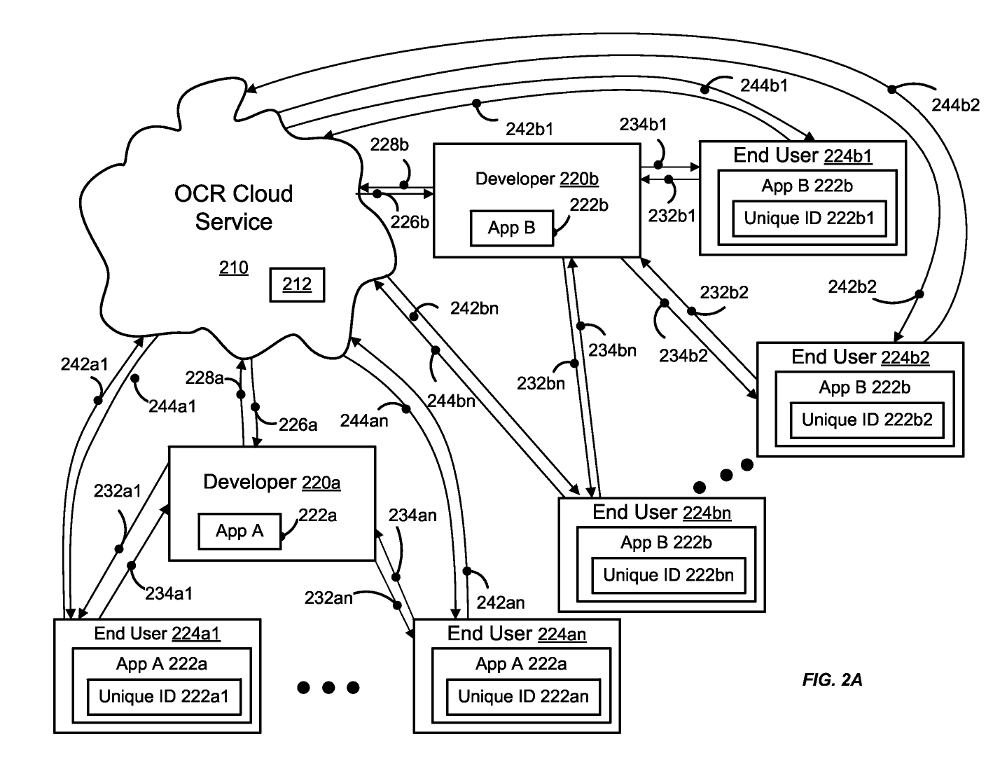

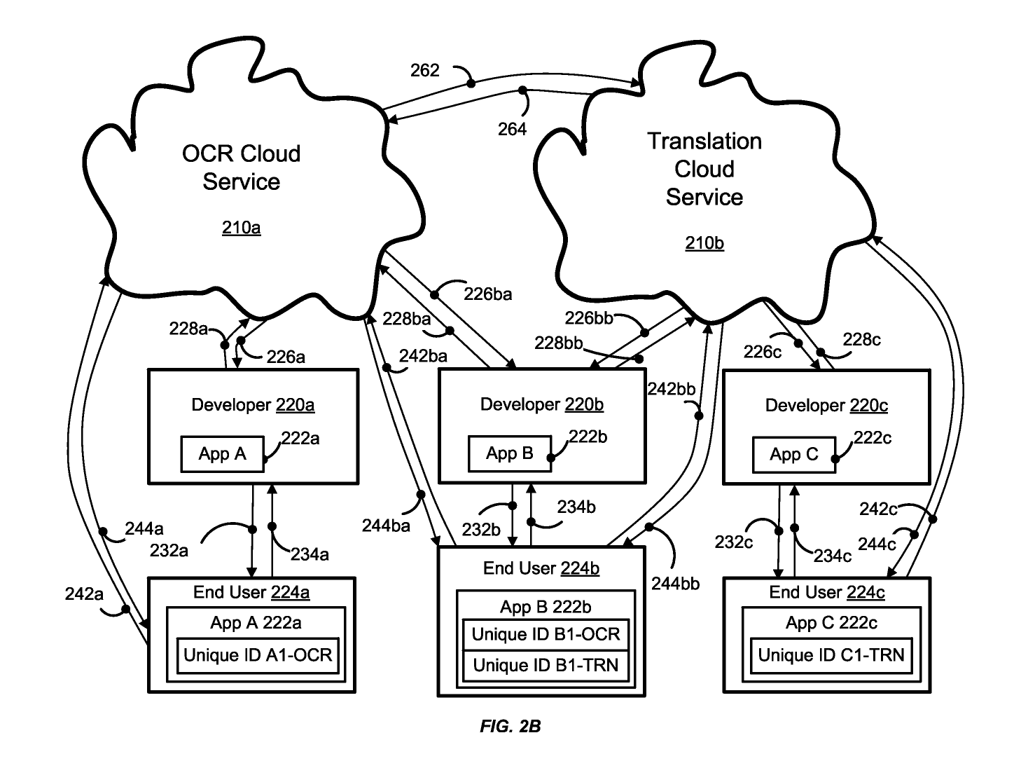

FIG. 2A shows a block diagram of an exemplary system for predicting usage of a cloud based service according to an embodiment of the invention. According to the method shown in FIGS. 1A and 1B, in one embodiment there is a test phase during which time the usage of a service in the cloud by end users of developers participating in the test is monitored (step 120). During the test phase, statistics regarding the software service usage are monitored and stored.

In one embodiment, the future usage payment cost to the developer is a single fixed fee payment, where the single fixed fee payment is determined by monitoring the usage of a service by end users of the participating developer for a predetermined test period. In one example, the predetermined test period is a fixed period of time before payment is received and before an official price is published for the cloud service. During the test period, the service provider makes the service available to developers, often for no cost to the developer during the test or promotional period.

If after the test period, the developer wants to continue to use the service then the developer can choose to pay a fee for use of the service after the test period. The fee (the future usage payment cost) is calculated based on usage during the test period. After the test period, the developer is required to pay a future usage payment cost to enable the end users associated with the mobile program to be able to continue to use the service, after the test period. The payment made after the test period is not made for the services delivered during the “free” test period. Instead the payment made (the future usage payment cost) is a payment made by the developer for services rendered after the test period.

Once the mobile program developer publishes his software program and the end user can gain access (i.e., by purchasing the mobile program from a developer), the mobile program is available for use on the end user's mobile device. In the example shown in FIG. 2A, the mobile program includes an OCR capability that is performed by an OCR service. In one example, after the mobile program 222a, 222b is installed onto the end user's mobile device, (e.g. mobile phone), the end user may use the mobile phone camera, for example, to capture images of documents or other objects that need to be recognized, for example by the mobile program. The mobile program can provide its account prerequisites (such as unique ID and password, or using other identification methods) to the cloud service provider's server 212 to access the service.

In one embodiment, before the test period begins, the cloud service provider creates an account for the mobile program developer in order to uniquely identify the developer. For an implementation where the service is in the cloud, the mobile program developer communicates with the server where the cloud service is located. FIG. 2A shows a block diagram of an exemplary system for a usage based cloud service according to an embodiment of the invention. For purposes of example, the cloud based service in FIG. 2A is described with respect to an OCR service 210. However, the described invention is applicable to any usage based service (OCR, translation, voice recognition, etc.). For example, FIG. 2B shows a translation service 210b, where a file that OCR has been applied to is then transferred to the translation service from an end user is translated from a first language to a second language.

Referring to FIG. 2A shows a cloud service provider 210. The cloud service provider 210 provides an OCR service that is used by at least one mobile program developer. In the example shown in FIG. 2A, the OCR service is communicatively coupled both to a first mobile program developer 220a that distributes an Application A and a second mobile program developer 220b that distributes an Application B. The OCR service provider communicates with the mobile program developers 220a, 220b by communication channels 226a, 226b and 228a, 228b respectively.

Referring to FIG. 2A, the first and second mobile program developers 220a, 220b are communicatively coupled to a plurality of end users. Mobile program developer 220a is communicatively coupled to end users 224a1-224an through communication channels (232a1, . . . 232an) and (234a1, . . . 234an) while mobile program developer 220b is communicatively coupled to end users 224b1-224bn through communication channels (232b1, . . . 232bn) and (234b1, . . . 234bn). In addition, the end users 224a1-224an and end users 224b1-224bn are both communicatively coupled to the cloud service provider 210. End users 224a1-224an communicate with the cloud service provider 210 through communication channels 242a1-242an and 244a1-244an. End users 224b1-224bn communicate with the cloud service provider 210 through communication channels 242b1-242bn and 244b1-244bn.

Although shown connected to only a first and second mobile program developers 220a, 220b, this connection to only two developers 220a, 220b is for illustration purposes only as the cloud service provider may be connected to any number of mobile program developers n, where n is a positive integer value that the system or network is capable of supporting. In addition, the communication channels shown for communicatively coupling the cloud service providers, developers, and end users may be any type of communication channel (including, wired, wireless, optical, etc.) capable of communicating between service providers, end users and program developers.

Referring to FIG. 2A, during registration of the developer account, the cloud service provider 210 specifies the address of its server and also the prerequisites of access (i.e. login and password or other authentication method) to the mobile program developers 220a, 220b who wish to use the cloud service. After registration, the mobile program developer includes in the program (Application A 222a for developer 220a, Application B 222b for developer 220b)—specific code that accesses the cloud service provider's server using the mobile program's account prerequisites (such as program ID and password, unique URL, etc.).

FIG. 1A shows the step of associating a unique identifier with each program installed by an end user (step 130). During the first communication (the first use) of the installed mobile program with the cloud service, a unique ID is assigned to the current copy of the program installed onto current end user's mobile device. As an example, referring to FIG. 2A, after the first communication of the installed mobile program (Application A 222a) where the first communication occurs along communication channel 242a1, a unique ID (Unique ID222a1) is assigned by the server 212 of the OCR cloud service provider to the current copy of the program (Application A 222a) installed onto the current user's (end user 224a1) mobile device.

As previously stated, a unique identifier (unique ID) is associated with each mobile program installed by the developer for a specific end user (step 130). The total future usage payment cost that is paid by the developer is dependent upon the number of mobile programs installed. For example, if the mobile program Application A 222a is installed by the developer only once on an end user's single mobile device, the future usage payment cost will be paid once. If the mobile program is installed on ten of the end user's mobile devices (i.e. ten phones) then the developer will need to pay the future usage payment cost ten times—one time per usage of the copy of the mobile program on the end user's device. In one example, the unique ID is generated each time a mobile program is installed. In a second alternative example, the unique ID can be an identification that is unique across all manufactured devices or all existing users of such devices.

In a second alternative embodiment, when requesting a unique ID from the server 212, the mobile program may optionally pass to the server 212 a Device ID (—an identification that is unique across all manufactured devices) or a User ID (an identification that is unique across all existing users of such devices) and is obtainable programmatically using mobile OS API. An example of Device ID is phone EMEI. An example of a User ID—is an Apple ID. For security reasons, the mobile program may pass hash values of such ID's instead of their actual values. The service provider server will return same unique ID for subsequent calls with the same Device ID or User ID. This is important for cases when there is a possibility that the mobile program can be reinstalled on the same mobile device without making new purchase. This would occur for example when restoring data on a mobile device from backup after a hard reset, or when a mobile program is deleted from the mobile device with all its data and later reinstalled on the mobile device.

Referring to the method in FIG. 1A, the method of determining access to a cloud service includes the steps of associating a unique ID with each program installed by an end user (step 130) and providing (first) the unique ID to the end user. After the first call (from the mobile program 222a installed on the end user's device to the cloud service provider server 212), the cloud service provider server 212 associates or assigns a unique ID (step 130) to the end user 224a1 where the unique ID is received by the mobile program 222a and stored. For each subsequent call to the cloud service provider, the cloud service provider server 212 receives the unique ID from the end user (step 140). In one example, the cloud service provider then checks the unique ID and verifies that the unique ID is valid and is authorized to receive the service.

In the case where the end user must reinstall the mobile program with or without a hard reset, then a new unique ID will be assigned by the cloud service provider server 212 at the first call after the reset. However, if for this case there is already an existing Device ID or User ID, then in this case the mobile program 222a will receive from the cloud service provider server 212, the same unique ID as received for the previous installation of the mobile program.

FIG. 1A shows a flowchart of the method for determining access to a usage based cloud service based on an embodiment of the invention. The method 100 includes the steps of: monitoring the usage of a service by end users of developers for a predetermined test period (step 120). FIG. 1B shows a flowchart of operations to define an approximate cost of using a cloud service for developers according to an embodiment of the invention. Referring to FIG. 1B, the step of monitoring the usage of a service by end users for a predetermined test period (step 120) includes the steps of running the cloud service in the test mode (step 102) and the step of accumulating usage statistics (step 104).

During the test period, each mobile program developer 220a, 220b can get a free account (login, password) with the cloud service provider. The mobile program developer can use the account to connect his mobile program to the server of the cloud service provider. In one example, only a limited number of developers get a free account during the test period. In another alternative example, only a limited number of program installations can be allowed during the test period.

The timing of when the developer makes payment to the cloud service provider may vary. In one embodiment, during the test period the mobile program developer does not pay for service to provider of cloud service. In one example, access can be free for a limited trial period. In another example, access can be free to a limited number of end users. In one example, free access can be given to the developers of mobile programs where free access means that the OCR cloud service provider puts onto the developer's program account some quantity of “prepaid” installations, for example 1000 installations. In one example, usage of the cloud service is activated by the activation of a promotional code. In another example, the test period for monitoring the usage of the cloud service is set to the same time period of a promotional or limited time period.

During the test period, the provider of the cloud service can accumulate statistics (step 104) on usage of the cloud service by the mobile program developer. For the example of an OCR cloud service, the cloud service provider can measure the distribution of the number of page recognitions per day depending on number of days that have passed since program installation.

In one example, the statistics gathered (and the future usage payment cost calculated) are calculated based on all of the mobile program developers participating during the test period. In an alternative example, statistics might be gathered for a subset of developers (a developer group). In one example, the developer group could be a group of programs having a similar type (i.e. banking programs). In one example, a single developer might form the developer group.

In one example, the service provider has a list of unique IDs and the programs (and therefore the developers) that each unique ID is associated with. For this case, the service provider can choose to filter the statistics based on the different developers of interest (based on the unique IDs of the end users.) In one example, the developer group is distinguished from other developers in order to charge a different rate for different developer groups.

In one example, the service provider may wish to have different flat fee payment, for different classes of developers or developer groups. For example, the service provider might charge one flat fee payment for a group of mobile developers (developer group) associated with public institutions such as schools and have a second flat fee payment for the developer group associated with commercial institutions. Statistics could be gathered for all developers—but different flat fee payments might be charged to different developer groups based on the desire to receive a different profit rate for different developer groups.

In one embodiment, in addition to statistics being gathered by running the test operation of an OCR cloud service, the provider of the cloud service can optionally receive statistics of usage (step 106) that were gathered from another source. In one example, the usage statistics can be delivered from unsealed source. In another example, the usage statistics can be from paid or unpaid sources. For example, usage statistics can be received from marketing market research, reports of companies selling mobile programs or other sources.

Referring to FIG. 1A, the step determining a future usage payment cost based on based on the monitored statistics (step 120) is implemented in steps 110, 112, 114, 116 and 118 of FIG. 1B. In one example, the future usage payment cost is based on a usage model for the end users associated with a particular developer or developer group. In one example, the usage model can be based on a mathematical function that approximates end user usage.

Step 110 is the step of determining a relationship U(t) based on the accumulated usage statistics. For an OCR service, for example, usage is based on the number of pages recognized by the OCR service. For step 110 for an OCR service, there are U pages, where U is a number of pages recognized per day, and t is the time, the argument of a function U(t). Optionally, data received from marketing sources (steps 106, 108) can be used for fine tuning of the relationship U(t).

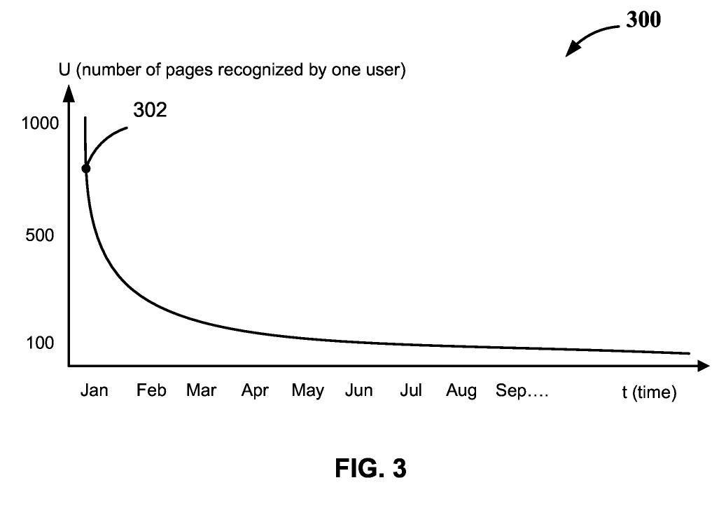

In one example, after a usage relationship is determined the relationship is approximated (step 112) by a suitable mathematical function. In one embodiment, the function which describes this relation can be inverse exponential curve 302 shown in FIG. 3. Referring to FIG. 3 shows an example of mathematical function that approximates a relationship between service usage and time according to the method shown in FIG. 1B. For the case where the service is an OCR cloud service, the service usage is related to the number of pages recognized and transformed by the OCR cloud service. In one example, the service usage is the average number of pages that are recognized and transformed by the cloud service per day with one installed program (one unique ID).

In one example, the relationship is approximated (step 112) by a mathematical function. In one example, a formula describing the function can be written as the function U(t)=M*e^{(-P*t)}; where M is a multiplier and P is an index. The values of M and P can be found due to an approximation based on the statistical data collected.

In one embodiment, the mobile program purchased by the end user has no expiration date. In this case, it may be desirable when determining the cost model for the cloud service—to determine the probable lifespan of the program so that the usage of the service can be estimated over the lifetime of the program. Referring to FIG. 1B, one of the steps in determining the average lifecycle of the mobile program is optional step 114 of calculating T, where T is the average lifecycle of the mobile program. The calculation of the value T varies and can be performed with different formulae depending of function approximated in step 112. The calculation of the value of T is optional, however, it helps provide a more accurate estimation of the lifetime of the mobile program.

After collecting the usage statistical data, the usage value of N (where N is the average number of pages recognized by single user during whole lifecycle T of the mobile program) can be determined (step 116). The calculation of N can be performed with different formulae depending of function approximated (step 112). In one embodiment, the determination can be performed with a time integral.

Step 118 is the calculation of C “cost of using the OCR cloud service per one installation” for the software developer. This calculation is carried out with consideration for calculated values of N and T. In particular, calculation of the cost C can be carried out like that so that the prices of recognition of one page in a proposed method are comparable to value of recognition of one page in traditional methods.

Another method includes a method for paying for usage cloud service is described. In one example, the method includes the steps of assigning a unique identifier for each copy of the program installed onto a mobile device; and determining a future usage payment cost of the mobile program wherein the future usage payment cost is a single payment for each program installation. During the “free” test period, service is provided to the end user with valid identification with no payment. After the test period ends, the cloud service provider also needs to verify receipt of a unique ID (step 150) before providing service to the end user. In one example, every time a request is made to access the service of the cloud service provider, the cloud service provider checks the unique ID. If the unique ID is correct (in other words, the user already registered for use of the OCR cloud service), the server of the cloud service provider allows the OCR program to perform recognition. Then the program passes the images to the OCR cloud service and receives a recognized text of documents. So, the program can use the OCR cloud service because of implemented access to the service. In one example, payment is assumed to have been received when the service provider receives a valid unique ID.

The proposed method provides a simple payment method that allows removes accounting issues dealing with expiration dates of the account and keeping track of pages used and pages left on the account. Further, by collecting large volumes of statistics across a plurality of developers, large quantities of data related to usage of the service are aggregated. Average usage values can be calculated from the aggregation of statistical values. Although there are some deviations from average values, these deviations in usage for each end user are absorbed by large installed-base. Therefore with minimized detriment to profitability, the service provider can assume risks on a program lifetime and usage. The method will also allow the mobile program developers to minimize the risks of varying usage among different customers. Further, the described system and method minimizes risks associated with unpredictable lifespan of application instances, and the necessity to maintain subscription to cloud OCR service even if application is not selling anymore, but some users still using it.

The mobile program developer sends program code which during the first application launch on a new device receives from cloud server unique ID. Server generates unique ID that is saved by the program and used during communication with the cloud service provider. Each program installation has a unique ID. In one example, the cloud service provider can use the unique ID to receive different statistics subsets. In one example, the cloud service provider doesn't need to count recognized pages by a single end user or the days that passed since first login of the end user. All of this information is associated with gathering automatically due to unique IDs existing in each installed program copy.

FIG. 2B shows a block diagram of an exemplary system for determining access to multiple usage based cloud services according to an embodiment of the invention. The block diagram shown in FIG. 2B is similar to the configuration shown in FIG. 2A. However, in the example shown in FIG. 2B there are two cloud services shown and three developers. The number of developers, end users and cloud service providers that is shown is for illustrative purposes only and the number of developers, end users and cloud service providers can vary. Further, although an OCR service and a translation service are shown, other types of cloud services may be implemented.

Referring to FIG. 2B shows a first cloud service provider 210a, where the first cloud service is an OCR service and a second cloud service provider 210b where the second cloud service provider is a translation service provider. In FIG. 2B, three mobile program developers 220a, 220b, 220c are shown interacting with the cloud service providers. The first developer 220a has provided an Application A 222a to an end user 224a. Similarly, the third developer 220c has provided an Application C 222c to an end user 224c.

Application B 222b is different than Application A 222a and Application C 222c shown in FIG. 2B. Instead of interacting with a single cloud service, Application B 222b is shown interacting with two cloud services. Specifically, Application B 222b is shown as having the capability of interacting with both OCR cloud service 210a and Translation cloud service 210b. Consider the case where an end user takes a photographic image with his camera of some text in English. Application B would have the capability of taking the image file that needs OCR recognition and then taking the English language text (recognized from the image file) and translating it to a second language (say for example, Russian or Spanish).

In one example, two unique IDs are generated for Application B. In one example, the transformed file (with OCR performed) is sent back to end user 224b and then the OCR transformed file is sent from end user 224b to the translation cloud service 210b. In another example, instead of the OCR transformed file being sent back to the end user 224b, the OCR transformed file sent directly from the OCR cloud service provider 210a to the Translation cloud service provider 210b. In this example, after the OCR transformed file is translated, the translated OCR file is sent to the end user 224b.

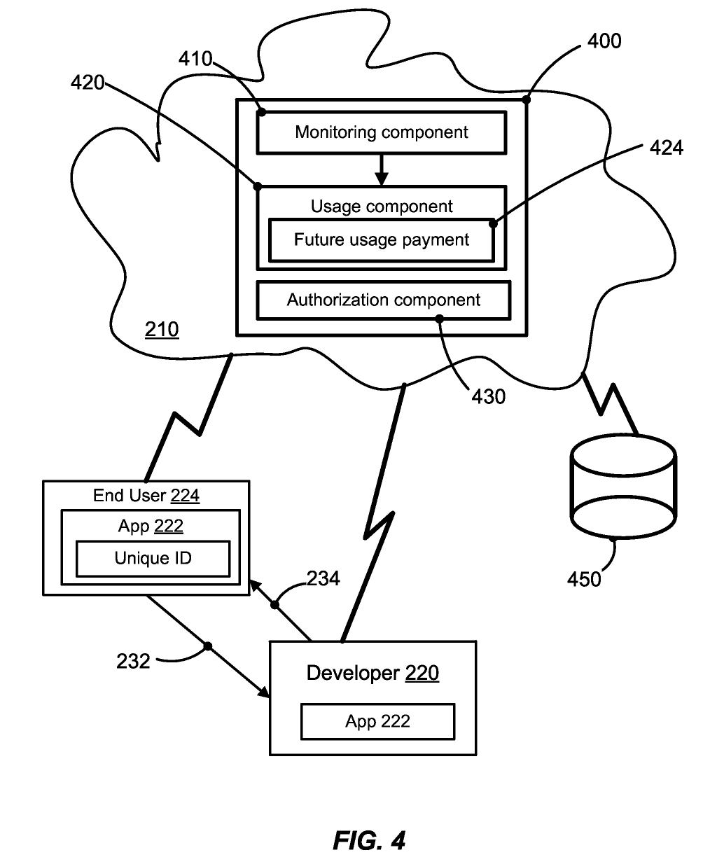

FIG. 4 shows a system for managing access to a cloud service according to an embodiment of the invention. Referring to FIG. 4 shows an end user 224 and a developer 220 communicatively coupled to the cloud service 210. For purposes of illustration, the block diagram shown in FIG. 4 shows only a single end user 224 and a single developer 220. However, it is understood that the system and methods described can be applied to a plurality of end users 224 and developers 220.

Referring to FIG. 4, the system for managing the cloud service includes a monitoring component 410 for monitoring the usage of a service by end users of a developer group for a predetermined test period; a usage component 420 for determining a future usage payment cost 424 for the developers, wherein the future usage payment cost is based on the monitored usage of the service by the end users during a predetermined test period; an authorization component 430 for verifying receipt of a future usage payment cost before performing the service wherein the service is performed by the service provider. The usage of the service is monitored after the predetermined test period ends, however, after the test period ends the monitoring can be used to modify and control the demand on the service.

The functions associated with the monitoring component 410, a usage component 420 and the authorization component 430 are associated with the described method. For example, the function of monitoring the usage of a service by end users of developers for a test period (performed by the monitoring component 410) is associated with step 120. The function of determining the usage component determining a future usage payment cost for the developers, wherein the future usage payment cost is based on the monitored usage of the service by the end users during a predetermined test period (performed by the usage component 420) is associated with step 122. The function of verifying received unique ID before performing the service wherein the service is performed by the service provider (performed by the authorization component 430) is associated with step 150.

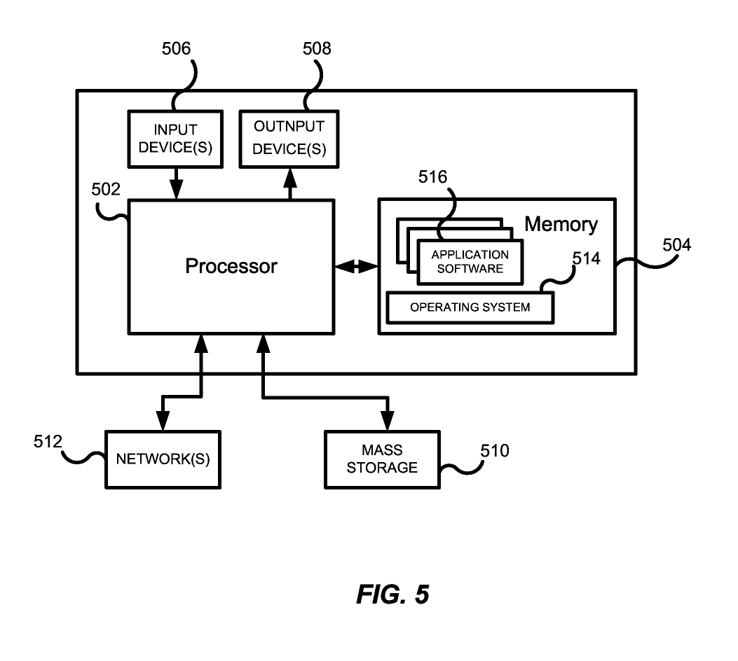

This method not only allows saving developer from his troubles of excess complexities. The method also allows making a developer an advantageous proposition. Also the method makes support of OCR cloud services more profitable to the cloud service providers. FIG. 5 shows a block diagram of a system for managing access to a cloud OCR service on which a computer readable medium may be used to receive program instructions for the method shown in FIG. 1A according to an embodiment of the invention. Referring now to FIG. 5, shows an example of hardware 500 that may be used to implement the techniques disclosed herein is shown, in accordance with an embodiment of the present disclosure. The hardware 500 typically includes at least one processor 502 coupled to a memory 504. The processor 502 may represent one or more processors (e.g., microprocessors), and the memory 504 may represent random access memory (RAM) devices comprising a main storage of the hardware 500, as well as any supplemental levels of memory e.g., cache memories, non-volatile or back-up memories (e.g. programmable or flash memories), read-only memories, etc. In addition, the memory 504 may be considered to include memory storage physically located elsewhere in the hardware 500, e.g. any cache memory in the processor 502, as well as any storage capacity used as a virtual memory, e.g., as stored on a mass storage device 510.

The hardware 500 also typically receives a number of inputs and outputs for communicating information externally. For interface with a user or operator, the hardware 500 may include one or more user input devices 506 (e.g., a keyboard, a mouse, a scanner etc.) and a display 504 (e.g., a Liquid Crystal Display (LCD) panel). For additional storage, the hardware 500 may also include one or more mass storage devices 510, e.g., a floppy or other removable disk drive, a hard disk drive, a Direct Access Storage Device (DASD), an optical drive (e.g. a Compact Disk (CD) drive, a Digital Versatile Disk (DVD) drive, etc.) and/or a tape drive, among others. Furthermore, the hardware 500 may include an interface with one or more networks 512 (e.g., a local area network (LAN), a wide area network (WAN), a wireless network, and/or the Internet among others) to permit the communication of information with other computers coupled to the networks. It should be appreciated that the hardware 500 typically includes suitable analog and/or digital interfaces between the processor 502 and each of the components 504, 506, 504 and 512 as is well known in the art.

The hardware 500 operates under the control of an operating system 514, and executes various computer software applications, components, programs, objects, modules, etc. indicated collectively by reference numeral 416 to perform the techniques described above. In general, the routines executed to implement the embodiments of the invention, may be implemented as part of an operating system or a specific application, component, program, object, module or sequence of instructions referred to as “computer programs”. The computer programs typically comprise one or more instructions set at various times in various memory and storage devices in a computer, and that, when read and executed by one or more processors in a computer, cause the computer to perform operations necessary to execute elements involving the various aspects of the invention. Moreover, while the invention has been described in the context of fully functioning computers and computer systems, those skilled in the art will appreciate that the various embodiments of the invention are capable of being distributed as a program product in a variety of forms, and that the invention applies equally regardless of the particular type of machine or computer-readable media used to actually effect the distribution. Examples of computer-readable media include but are not limited to recordable type media such as volatile and non-volatile memory devices, floppy and other removable disks, hard disk drives, optical disks (e.g., Compact Disk Read-Only Memory (CD ROMS), Digital Versatile Disks, (DVDs), etc.), among others.

Although the present invention has been described with reference to specific exemplary embodiments, it will be evident that the various modification and changes can be made to these embodiments without departing from the broader spirit of the invention. Accordingly, the specification and drawings are to be regarded in an illustrative sense rather than in a restrictive sense. This invention is not limited to the specific constructions and arrangements shown and described, since various other modifications may occur to those ordinarily skilled in the art upon studying this disclosure. In areas of technology related to this invention, where there is fast growth and further advancements are not easily foreseen, the disclosed embodiments may be readily modifiable in arrangement and detail as facilitated by enabling technological advancements without departing from the principals of the present disclosure.

1. A method for determining access to a service including the steps of:
monitoring the usage of a service by an end user associated with a developer for a predetermined test period;
generating a statistic associated with the monitoring of the usage of the service;
responsive to the statistic associated with monitoring during the predetermined test period, determining a future usage payment cost for the developer; and
performing the service wherein the service is performed by a cloud service provider.

2. The method recited in claim 1 further including the step of assigning a unique ID for each copy of a program installed onto a mobile device.

3. The method recited in claim 2 further including the step of determining a future usage payment cost for a developer of a program, wherein the future usage payment cost is the cost of a single installation.

4. The method recited in claim 3 wherein a total cost for the developer is the future usage payment cost multiplied by the number of installations of the program.

5. The method recited in claim 1 wherein the service is an optical character recognition (OCR) service.

6. The method recited in claim 2 wherein the unique ID is assigned by a cloud service provider server during a first call to the cloud service provider.

7. The method recited in claim 2 wherein the unique ID is assigned using a device unique identifier.

8. The method recited in claim 2 wherein the unique ID is assigned using an end user unique identifier, and wherein the unique ID is semi-unique to the end user.

9. The method recited in claim 1 wherein the service is a translation service.

10. The method recited in claim 1 wherein the service is a voice recognition service.

11. The method recited in claim 2 wherein the future usage payment cost is based on an average usage and average lifecycle of the program.

12. A system for managing access to a cloud service comprising:
a monitoring component for monitoring the usage of a service by an end user of a developer for a predetermined test period;
a usage component for determining a future usage payment cost for the developer, wherein the future usage payment cost is based on the monitored usage of the service by the end user during a predetermined test period;
an authorization component for verifying a unique ID before performing the service wherein the service is performed by a service provider.

13. The system recited in claim 12 wherein the authorization component further assigns a unique ID for each copy of a program installed onto a mobile device.

14. The system recited in claim 13 wherein the unique ID is assigned using a device unique identifier, and wherein verifying the unique ID includes authenticating the unique ID.

15. The system recited in claim 13 wherein the unique ID is assigned using an end user unique identifier.

16. The system recited in claim 13 wherein the future usage payment cost determined by the usage component is a cost of a single installation of the program.

17. The system recited in claim 16 wherein a total cost for the developer is the future usage payment cost multiplied by the number of installations of the mobile program.

18. The system recited in claim 12 wherein the service is an optical character recognition (OCR) service.

19. The system recited in claim 13 wherein the unique ID is assigned by a cloud service provider server during a first call to the cloud service provider.

20. The system recited in claim 12 wherein the service is a translation service.

21. The system recited in claim 12 wherein the service is a voice recognition service.

22. A non-transitory computer readable medium storing a program and causing a computer to execute the method, including the steps of:
monitoring the usage of a service by an end user of a developer for a predetermined test period;
responsive to the statistics associated with monitoring during the predetermined test period, determining a future usage payment cost for the developer; and
performing the service wherein the service is performed by a cloud service provider.

23. The computer readable medium recited in claim 22, the method further including the step of assigning a unique ID for each copy of a program installed onto a mobile device.

24. The computer readable medium recited in claim 23, the method further including the step of determining a future usage payment cost for a developer of a program, wherein the future usage payment cost is the cost of a single installation.

25. The computer readable medium recited in claim 24 wherein a total cost for the developer is the future usage payment cost multiplied by the number of installations of the mobile program.

26. The computer readable medium recited in claim 22 wherein the service is an optical character recognition (OCR) service.

27. The computer readable medium recited in claim 22 wherein the service is a translation service.

28. The computer readable medium recited in claim 23 wherein the unique ID is assigned by a cloud service provider server during a first call to the cloud service provider.
